(19) United States
(12) Patent Application Publication
(10) Pub. No.: US 2026/0312282 A1
(43) Pub. Date: Oct. 8, 2026

(54) ANTENNA DEVICE, ANTENNA, AND VEHICLE

(71) Applicants: YOKOWO CO., LTD., Tokyo (JP); TOYOTA JIDOSHA KABUSHIKI KAISHA, Toyota-shi, Aichi (JP)

(72) Inventors: Noritaka TERASHITA, Tomioka-Shi, Gunma (JP); Motohisa ONO, Tomioka-Shi, Gunma (JP); Kazusa KANOU, Tomioka-Shi, Gunma (JP); Takuma SAWAYA, Toyota-shi, Aichi (JP); Shogo KATOH, Toyota-shi, Aichi (JP)

(73) Assignees: YOKOWO CO., LTD., Tokyo (JP); TOYOTA JIDOSHA KABUSHIKI KAISHA, Toyota-shi, Aichi (JP)

(21) Appl. No.: 19/478,795

(22) PCT Filed: Apr. 10, 2024
(86) PCT No.: PCT/JP2024/014552

§ 371 Date: Oct. 24, 2025

(30) Foreign Application Priority Data
Apr. 27, 2023 (JP) 2023-073249

(51) Int. Cl. H01Q 1/52; H01Q 1/32; H01Q 21/30

(52) U.S. Cl. CPC H01Q 1/521; H01Q 1/3275; H01Q 21/30

(57) ABSTRACT

An antenna device including a plurality of antennas that are arranged, at a vehicle, along a width direction intersecting with a direction of travel of the vehicle, the antenna device includes: a first antenna supporting radio waves in a first frequency; and a second antenna supporting radio waves in a second frequency band having a fractional bandwidth narrower than the fractional bandwidth of the first frequency, wherein the second antenna is located on an outer side in the width direction of the vehicle relative to the first antenna, the second antenna.

### TECHNICAL FIELD

The present disclosure relates to an antenna device, an antenna, and a vehicle.

### BACKGROUND ART

PTL 1 discloses an antenna device including a plurality of antennas accommodated in an internal space of an antenna case.

### CITATION LIST

### Patent Literature

[PTL 1] Japanese Patent Application Publication No. 2016-208291

### SUMMARY OF INVENTION

### Technical Problem

When multiple antennas are accommodated in a limited space such as an antenna case, as in the antenna device of PTL 1, the characteristics of the respective antennas may be affected depending on the arrangement of the multiple antennas.

In view of such an issue described above, the present disclosure is directed to, for example, implementing an antenna device that enables multiple antennas to be appropriately arranged, an antenna constituting one antenna in the antenna device, and a vehicle to which the antenna device or the antenna is mounted. The present disclosure is directed also to others which will become apparent from the description of the present Description.

### Solution to Problem

An aspect of the present disclosure is an antenna device including a plurality of antennas that are arranged, at a vehicle, along a width direction intersecting with a direction o f travel of the vehicle, the antenna device comprising: a first antenna supporting radio waves in a first frequency; and a second antenna supporting radio waves in a second frequency band having a fractional bandwidth narrower than the fractional bandwidth of the first frequency, wherein the second antenna is located on an outer side in the width direction of the vehicle relative to the first antenna.

Another aspect of the present disclosure is an antenna comprising: one of a plurality of antennas that are included in an antenna device, the plurality of antennas being arranged, at a vehicle, along a width direction intersecting with a direction of travel of the vehicle, the antenna being located on an outer side in the width direction of the vehicle relative to the first antenna supporting radio waves in a first frequency, the antenna supporting radio waves in a second frequency band having a fractional bandwidth narrower than the fractional bandwidth of the first frequency

Still another aspect of the present disclosure is a vehicle mounted with a plurality of antennas that are arranged along a width direction intersecting with a direction of travel of the vehicle, the vehicle comprising: a first antenna supporting radio waves in a first frequency; and a second antenna supporting radio waves in a second frequency band having a fractional bandwidth narrower than the fractional bandwidth of the first frequency, the first antenna and the second antenna being mounted in this order from a center to an outer side in the width direction of the vehicle.

According to aspects described above of the present disclosure, it is possible to implement an antenna device in which multiple antennas are appropriately arranged, an antenna constituting one antenna in the antenna device, and a vehicle to which the antenna device or the antenna is mounted.

### BRIEF DESCRIPTION OF DRAWINGS

FIG. 1 is a side view, partially in cross section, of a vehicle C to which an antenna device 10 according to an embodiment of the present disclosure is provided.

FIG. 2 is a perspective view of a top face U of a vehicle C.

FIG. 3 is a perspective view of an antenna device 10.

FIG. 4 is a perspective view of a top face U of a vehicle C with housings 7, 8 removed.

FIG. 5 is a perspective view of an antenna device 1A with a housing 7 removed.

FIG. 6 is a side view of an antenna 4.

FIG. 7A is a top view of antenna devices 1A, 1B.

FIG. 7B is a front view of antenna devices 1A, 1B. Note that the illustration of an antenna 6 is omitted.

FIG. 8 is a side view of an antenna 5.

FIG. 9A is a diagram illustrating a relationship between a resonance frequency and a distance between elements in an antenna 3.

FIG. 9B is a diagram illustrating a relationship between a resonance frequency and a distance between elements in an antenna 2.

FIG. 10A is a diagram illustrating a relationship between a return loss and a distance between elements in an antenna 3.

FIG. 10B is a diagram illustrating a relationship between a return loss and a distance between elements in an antenna 2.

FIG. 11 is a table illustrating the sensitivity of an antenna 4 when antenna(s) 2, 3 is/are adjacent and when an antenna 4 is used alone.

FIG. 12A illustrates a result of calculation giving how the gain (dBi) in a horizontal plane of an antenna 5 varies in all directions when the antenna 5 is arranged at the center in a width direction.

FIG. 12B illustrates a result of calculation giving how the gain (dBi) in a horizontal plane of an antenna 5 varies in all directions when the antenna 5 is arranged off-center in a width direction.

FIG. 13A is a diagram illustrating a first example of the arrangement of an antenna 5.

FIG. 13B is a diagram illustrating a second example of the arrangement of an antenna 5.

FIG. 13C is a diagram illustrating a third example of the arrangement of an antenna 5.

FIG. 14A is a diagram of a first example illustrating a relationship between a roof panel C1 and antennas.

FIG. 14B is a diagram of a second example illustrating a relationship between a roof panel C1 and antennas.

FIG. 15A is a diagram illustrating a first example of the arrangement of diversity antennas arranged at a recessed portion R.

FIG. 15B is a diagram illustrating a second example of the arrangement of diversity antennas arranged at a recessed portion R.

### DESCRIPTION OF EMBODIMENTS

At least the following matters will become apparent from the description of the present Description and the accompanying drawings.

With reference to the drawings, preferred embodiments of the present disclosure will be described below. The same or equivalent components, members, and the like illustrated in the drawings are denoted by the same reference numerals, and redundant description thereof is omitted as appropriate.

In the following description, “substantially quadrilateral” or “rectangular” refers to a shape consisting of four sides including, for example, a square and a rectangle, and for example, at least some of the corners thereof may be cut off obliquely with respect to the side(s), or at least some of the corners may include a curve. Further, a “substantially quadrilateral” or “rectangular” shape may be such that some of the sides may be provided with a notch (recessed part) or a protrusion (projecting part).

### First Embodiment

### <<Overview of Antenna Device 10>>

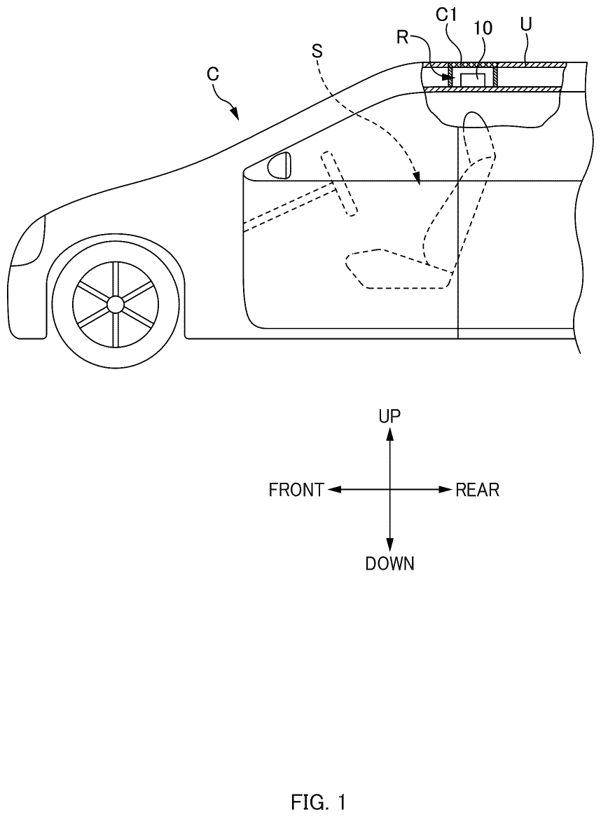

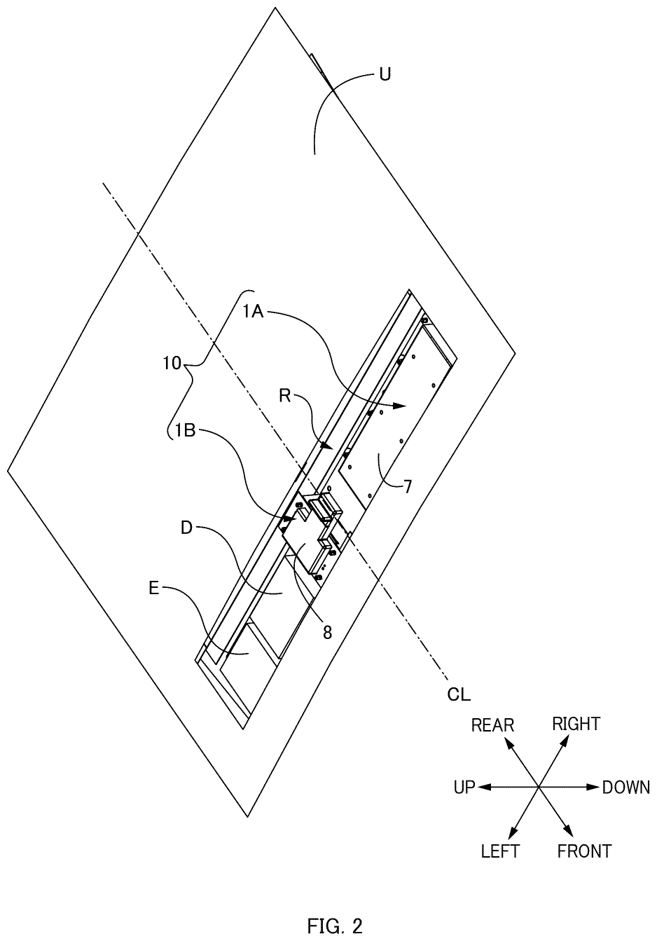

An overview of an antenna device 10 of an embodiment of the present disclosure will be described with reference to FIGS. 1 and 2

The antenna device 10 includes antenna devices 1A, 1B (described below) each including a plurality of antennas, and is a vehicular antenna device to be used in a vehicle C, which is a wheeled vehicle. Here, the antenna device 10 is not limited to an aspect in which it is mounted to the vehicle C, but may also include an aspect in which it is brought into the vehicle C and used in the vehicle C. In an embodiment of the present disclosure, the antenna device 10 is mounted, for example, to a recessed portion R that is located below a top face U (including a roof, loop panel, and back door) of the vehicle C as well as above a ceiling surface in a vehicle cabin. However, the antenna device 10 may be located somewhere other than the recessed portion R, such as at a spoiler, overhead console, or the like. Further, the antenna device 10 may be an antenna device for something other than a vehicle. The antenna device 10 may be used for, for example, a flight body such as a drone or like, and a mobile vehicle such as a probe, wheel-less construction machinery, agricultural machinery, vessel, or the like. Further, the antenna device 100 may be an antenna device used for something other than the mobile body.

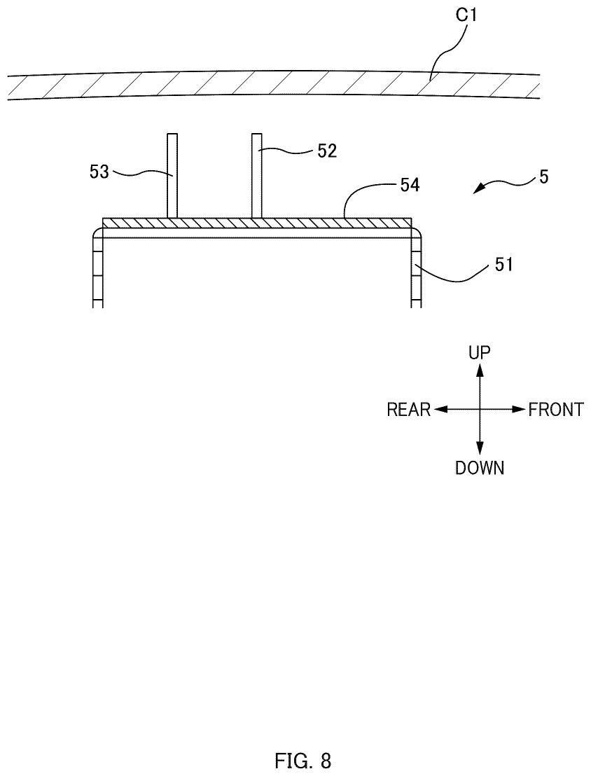

The top part of the recessed portion R is covered with a resin roof panel C1 constituting a part of the top face U (see FIG. 8 described below).

The size of the recessed portion R, in which the antenna device 10 is to be accommodated, is limited. Thus, it is needed to miniaturize the device constituting an antenna group that includes antennas 2, 3, 4, 5, and 6, while maintaining the sensitivity of each of the antenna 6, the antenna 5, or the antennas 2, 3, and 4, which will be described below.

In the following description, directions are defined with reference to the direction as seen from a driver's seat S of the vehicle C as illustrated in FIG. 1. Specifically, a forward direction as seen from a driver's seat S of the vehicle C is defined as front, and a direction opposite thereto (rearward direction as seen from the driver's seat S) is defined as rear. Further, a leftward direction as seen from the driver's seat S of the vehicle C that is also a direction perpendicular to a front-rear direction is left, and a direction opposite thereto (rightward direction as seen from the driver's seat S) is right. A left-right direction is also a width direction of the vehicle C. Further, an upward direction as seen from the driver's seat S of the vehicle C that is also a direction perpendicular to the front-rear direction and the left-right direction is defined as up, and a direction opposite thereto (downward direction as seen from the driver's seat S) is defined as down. The definitions of directions and the like described above are common to other embodiments in the present Description, unless otherwise specified.

The antenna device 10 includes the antenna device 1A and the antenna device 1B (see FIG. 2, for example).

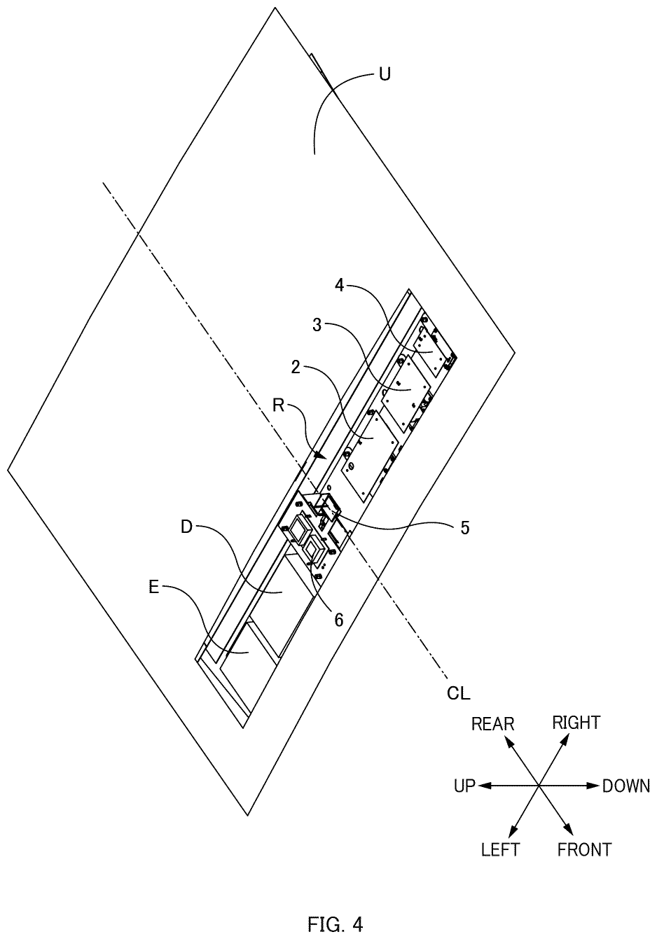

The antenna device 1A includes a substantially rectangular parallelepiped-shaped housing 7 that covers the antenna 2, the antenna 3, and the antenna 4, and covers, from above, the antennas 2, 3, and 4, as illustrated in FIGS. 2 to 8. In addition, the antenna device 1A includes the ground portion 9, which functions as the ground of the antennas 2, 3, and 4, on the lower side relative to the antennas 2, 3 and 4. The antenna device 1A is provided on the right side relative to a diversity antenna E and a diversity antenna D, in the recessed portion R. The diversity antenna E, D may be an antenna other than that, or may be an electronic device, such as a communication module, a receiving unit, a camera unit, or the like.

The antenna device 1B is provided on the left side relative to the antenna device 1A, as illustrated in FIGS. 2 to 8. The antenna device 1B includes a housing 8 that covers the antenna 5 and the antenna 6, and covers the antennas 5 and 6 from above. The antenna 5 is located on a center line CL of the vehicle C in the width direction. First, each of the antennas 2, 3, and 4 included in the antenna device 1A will be described.

### (Antenna 2)

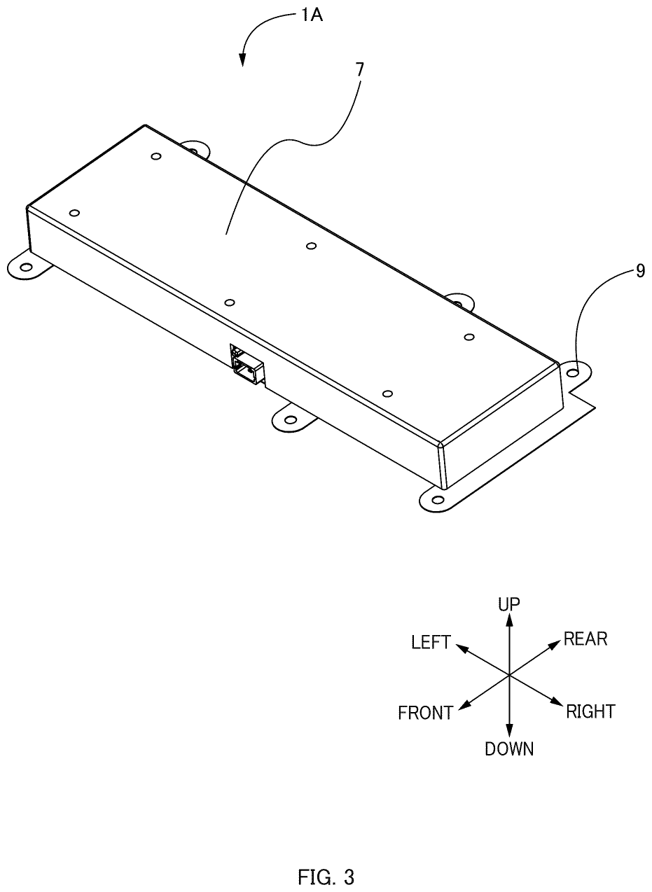

The antenna 2 is arranged on the leftmost side and closest to the center line CL among the antenna 2, the antenna 3, and the antenna 4, as illustrated in FIGS. 3, 4, 5, 6, 7A, and 7B. The antenna 2 is an antenna that can receive a digital radio broadcast (Digital Audio Broadcasting, hereinafter referred to as “DAB”) and corresponds to the frequency band of 174 MHz to 240 MHz (hereinafter, may be referred to as “DAB frequency band”). For example, the antenna 2 may be an antenna supporting radio waves in frequency bands used for GSM, UMTS, LTE, telematics, Wi-Fi, Bluetooth, and/or the like. Further, the antenna 2 may support part of the radio waves in a frequency band (for example, only for 5G) among those for these frequency bands. Note that Wi-Fi and Bluetooth are registered trademarks.

The antenna 2 will be described below in detail.

### (Antenna 3)

The antenna 3 is an FM antenna provided on the right side relative to the antenna 2 with a distance therebetween, as illustrated in FIGS. 3, 4, 5, 6, 7A, and 7B. The antenna 3 supports the frequency band having a fractional bandwidth narrower than that of the antenna 2, and, in an embodiment of the present disclosure, supports the frequency band of 88 MHZ to 108 MHZ, which is the frequency band of a Frequency Modulation (FM) broadcast (hereinafter, may be referred to as “FM frequency band”), so as to be able to receive it.

Note that the antenna 3 may be an antenna supporting radio waves in frequency bands used in GSM, UMTS, LTE, telematics, Wi-Fi, Bluetooth, and/or the like. Further, the antenna 3 may support part of the radio waves in a frequency band (for example, only for 5G) among those in the frequency bands. Even when any frequency band is to be supported, the fractional bandwidth of the antenna 3 is arranged to be narrower than the fractional bandwidth of the antenna 2.

The antenna 3 will be described below in detail.

### (Antenna 4)

The antenna 4 is provided on the right side relative to the antenna 3 with a distance therebetween as illustrated in FIGS. 3, 4, 5, 6, 7A, and 7B. The antenna 4 is an antenna that receives a medium-wave broadcast, and, in an embodiment of the present disclosure, supports the frequency band of 530 kHz and 1710 KHZ of an Amplitude Modulation (AM) broadcast from (hereinafter, may be referred to as “AM frequency band”), so as to be receivable.

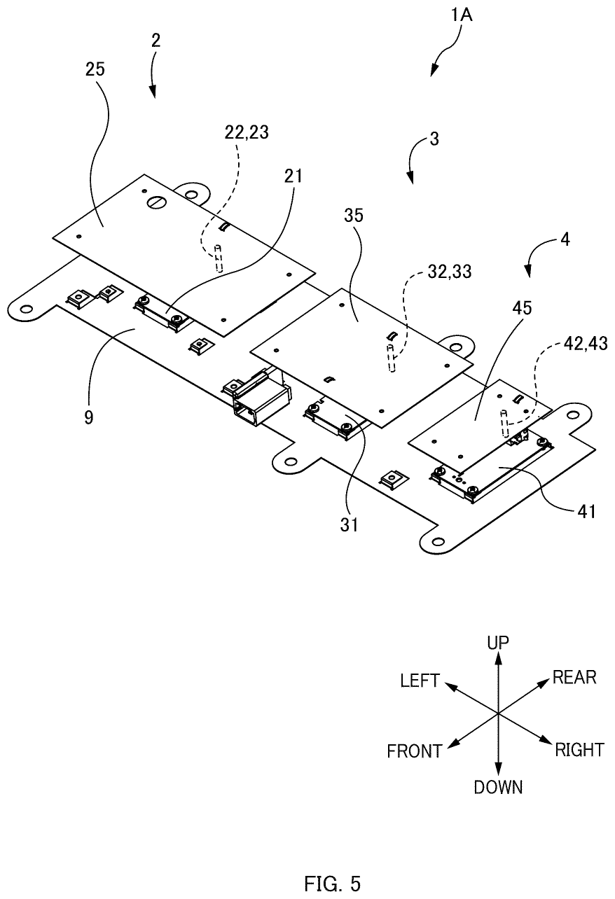

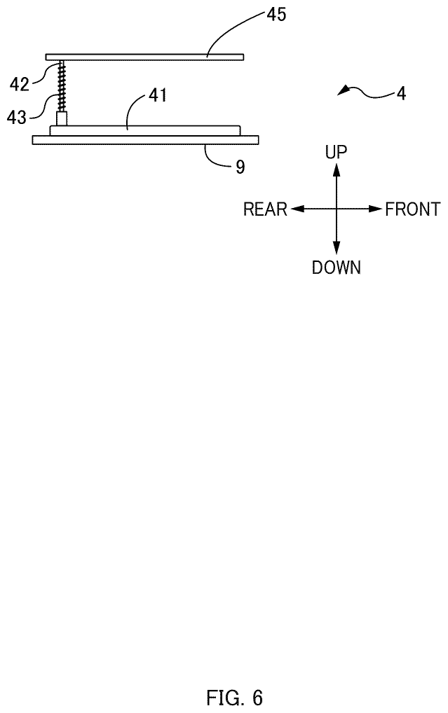

The antenna 4 is an AM antenna based on an inverted-L type, and includes a substrate 41, a support portion 42, a coil 43, and an element 45 supported by the support portion 42 so as to be substantially parallel to the ground portion 9 (see FIGS. 5 and 6).

The substrate 41 is a substantially rectangular substrate provided to the top face of the ground portion 9 and is electrically connected to the ground portion 9. An electronic component (not illustrated) such as an amplifier that amplifies a signal from the antenna 4 is mounted to the substrate 41.

Note that being “connected” includes being “electrically connected”, without being limited to being physically connected. In addition, electrical connection includes connection using an electronic circuit, an electronic component, or the like, without being limited to connection using a conductor. The same applies to the following explanation.

The support portion 42 is a member that supports the element 45 such that the element 45 is substantially parallel to the ground portion 9, and is provided to the substrate 41 so as to extend upward above the substrate 41. A coil 43 electrically connected to the substrate 41 is wound around the outer periphery of the support portion 42. The coil 43 is an element that supports the radio waves in the frequency band of the AM broadcast together with the element 45, and is connected to the element 45 and the substrate 41. Note that the support portion 42 may be constituted by a conductor wire or a conductor plate, and may be connected to the element 45 and the substrate 41, with the coil 43 being omitted.

The element 45 is a flat-plate-shaped capacitive loading element made of a conductor such as metal, and is formed in a substantially rectangular shape when seen from above. The element 45 is provided to the top part of the support portion 42 and electrically connected to the coil 43. The front-to-rear length of the element 45 is substantially 70 mm, and the left-to-right width thereof is substantially 40 mm. Note that the element 45 may have a shape so as to suppress interference with other antennas, such as a meandering shape or a spiral shape, as long as the area of the element 45 can be effectively utilized.

The explanation of the inverted-L antenna structure of the antenna 4 using FIG. 6 is similarly applicable to the antenna 2. That is, the antenna 2 is a DAB antenna based on the inverted-L type, and includes a substrate 21, a support portion 22, a coil 23, and an element 25 supported by the support portion 22 so as to be substantially parallel to the ground portion 9 (see FIG. 5).

The substrate 21, as with the substrate 41 of the antenna 4, is a substantially rectangular substrate provided to the top face of the ground portion 9, and is electrically connected to the ground portion 9. An electronic component (not illustrated) such as an amplifier that amplifies a signal from the antenna 2 is mounted to the substrate 21.

The support portion 22, as with the support portion 42 of the antenna 4, is a member that supports the element 25 such that the element 25 is substantially parallel to the ground portion 9, and is provided to the substrate 21 so as to extend upward above the substrate 21. Although not illustrated In FIG. 5, the coil 23 is wound around the outer periphery of the support portion 22, and is electrically connected to the substrate 21. The coil 23 is an element that supports the radio waves in the DAB frequency band, together with the element 25, and is connected to the element 25 and the substrate 21. Note that the support portion 22 may be constituted by a conductor wire or a conductor plate, and may be connected to the element 25 and the substrate 21, with the coil 23 being omitted.

The element 25, as with the element 45 of the antenna 4, is a flat-plate-shaped capacitive loading element made of a conductor such as metal, and is formed in a rectangular shape when seen from above. The element 25 is provided to the top part of the support portion 22, and electrically connected to the coil 23. The front-to-rear length of the element 25 is substantially 70 mm, and the left-to-right width thereof is substantially 130 mm. Note that the element 25 may have a shape so as to suppress interference with other antennas, such as a meandering shape or a spiral shape, as long as the area of the element 25 can be effectively utilized.

Further, the explanation of the inverted-L antenna structure of the antenna 4 using FIG. 6 is similarly applicable to the antenna 3. That is, the antenna 3 is the FM antenna based on the inverted L type, and includes a substrate 31, a support portion 32, a coil 33, and an element 35 supported by the support portion 32 so as to be substantially parallel to the ground portion 9 (see FIG. 5).

The substrate 31, as with the substrate 41 of the antenna 4, is a substantially rectangular substrate provided to the top face of the ground portion 9, and is electrically connected to the ground portion 9. An electronic component (not illustrated) such as an amplifier that amplifies a signal from the antenna 3 is mounted to the substrate 31.

The support portion 32, as with the support portion 42 of the antenna 4, is a member that supports the element 35 such that the element 35 is substantially parallel to the ground portion 9, and is provided to the substrate 31 so as to extend upward above the substrate 31. Although not illustrated in FIG. 5, the coil 33 is wound around the outer periphery of the support portion 32, and is electrically connected to the substrate 31. The coil 33 is an element that supports the radio waves in the FM frequency band together with the element 35, and is connected to the element 35 and the substrate 31. Note that the support portion 32 may be constituted by a conductor wire or a conductor plate, and connected to the element 35 and the substrate 31, with the coil 33 being omitted.

The element 35 is, as with the element 45 of the antenna 4, a flat-plate-shaped capacitive loading element made of a conductor such as metal, and is formed in a substantially rectangular shape when seen from above. The element 35 is provided to the top part of the support portion 32, and is electrically connected to the coil 33. The front-to-rear length of the element 35 is substantially 70 mm, and the left-to-right width thereof is substantially 100 mm. Note that the element 35 may have a shape so as to suppress interference with other antennas, such as a meandering shape or a spiral shape, as long as the area of the element 35 can be effectively utilized.

At least two of the substrate 21 of the antenna 2, the substrate 31 of the antenna 3, and the substrate 41 of the antenna 4 described above may be integrated as the same member.

Next, an explanation will be given of the antennas 5 and 6, which are included in the antenna device 1B that is provided on the left side relative to the antenna device 1A.

### (Antenna 5)

The antenna 5 supports the radio waves in a frequency band used in, for example, Vehicle to Everything (V2X: vehicle-to-vehicle communication, road-to-vehicle communication), so as to be able to transmit and receive them.

The antenna 5 is an antenna included in the antenna device 1B and arranged on the left side relative to the antenna device 1A, as illustrated in FIGS. 2, 4, 7A, and 7B, and is arranged substantially at the center in the width direction with respect to the vehicle C. The antenna 5 includes a ground portion 51, an element 52, a reflector 53, and a flat-plate-shaped and substantially rectangular substrate 54 (see FIG. 8).

The ground portion 51 is a substantially rectangular parallelepipedo-shaped member formed of a conductor such as metal, and is electrically connected to the vehicle C. Note that the ground portion 51 may be formed integrally with the vehicle C, or may be a member separate from the vehicle C. In an embodiment of the present disclosure, the height of the ground portion 51 from the bottom face of the recessed portion R is determined such that the characteristics of the antennas 5, 6 are desirable.

The element 52 is a rod-shaped conductor that operates as a vertically polarized monopole antenna used in V2X communication, and extends upward from the substrate 54. The element 52 is provided substantially at the center in the width direction of the vehicle C.

Note that the length of the element 52 extending upward may further increase such that the roof panel C1 bulges upward such that the element 52 is located below the roof panel C1 of the vehicle C.

The reflector 53 is a rod-shaped conductor provided near the element 52, and is attached so as to extend upward from the substrate 54. The reflector 53 is a parasitic element that functions as a so-called reflector and has a function of improving the gain of the antenna 5 in the forward direction of the vehicle C.

### (Antenna 6)

The antenna 6 is a patch antenna arranged on the left side relative to the antenna 5. The antenna 6 is used in Global Navigation Satellite System (GNSS), and supports the frequency band in GNSS, so as to be able to receive it. The frequency band in GNSS is, for example, the L1 band (center frequency: 1575.42 MHz), the L2 (center frequency: 1227.60 MHz), or the L5 band (center frequency: 1176.45 MHz).

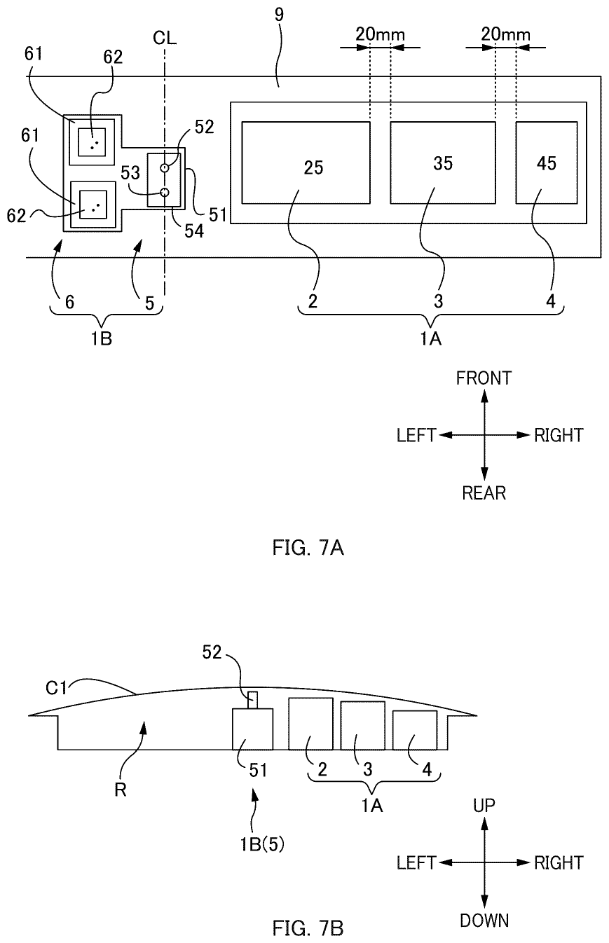

The antenna 6 is provided on the ground portion 51, as illustrated in FIG. 7A, and includes a flat-plate-shaped dielectric 61 arranged on the left side relative to the antenna 5, and a radiating element 62 provided at the top part of the dielectric 61. The antenna 6 has a function of a patch antenna and is placed on the top face of the ground portion 51.

Note that the ground portion 51 may be formed integrally as described above, or may be divided into two or more and the antenna 5 and the antenna 6 are grounded separately.

The dielectric 61 is made of a dielectric material such as ceramic and the like. The radiating element 62 supports the radio waves in the L1, L2 and L5 bands. Note that the configuration is not limited thereto, but various configurations of the patch antenna may be used, such as a laminated patch antenna, a patch antenna that resonates with the radio waves of multiple frequency bands, a patch antenna formed of sheet metal without using a dielectric material, a patch antenna that combines the above, and the like. Furthermore, the parasitic element that adjusts the directivity in the direction of the angle of elevation may be arranged on the upper side relative to those patch antennas or arranged therearound.

### (Ground Portion 9)

As illustrated in FIGS. 3, 5, and 6, the ground portion 9 is formed of a substantially quadrilateral member when seen in the up-down direction. The ground portion 9 is electrically and mechanically connected to the vehicle C using a joint element such as a screw, and functions as the ground of the antennas 2, 3, and 4 included in the antenna device 1A. However, alternatively, the ground portion 9 may function as the ground of only some antenna(s) of the antennas 2, 3, and 4. For example, the ground portion 9 may function as the ground of the antenna 2, and another ground portion may function as the ground of the antennas 3, 4. The method of joining the ground portion 9 to the vehicle C can include other methods such as welding, adhering, or the like, in addition to using the joining element.

In an embodiment of the present disclosure, the ground portion 9 is formed as an integral metal plate (sheet metal) as illustrated in FIG. 5. However, the ground portion 9 may be constituted by a plurality of separate metal plates. For example, the ground portion 9 may have a configuration in which a metal plate provided with the antennas 2, 3 and another metal plate provided with the antenna 4 are electrically connected.

Note that the ground portion 9 may be formed of a member other than a plate-shaped one, as long as the ground portion 9 functions as the ground of the antenna included in the antenna device 1A. Further, the ground portion 9 may include any combination of a member made of metal and a member made of a material ther than metal, as long as the ground portion 9 functions as the ground of the antennas included in the antenna device 1A. For example, the ground portion 9 may include a metal plate and an insulator made of resin. Further, the ground portion 9 may be constituted by a single substrate in which a conductive pattern is formed in a printed-circuit board (PCB).

### (Distance Between Antennas 2 and 3)

The elements 25, 35 are arranged with a predetermined distance therebetween as in FIGS. 7A and 7B. This distance is preferably set to 20 mm for the following reasons.

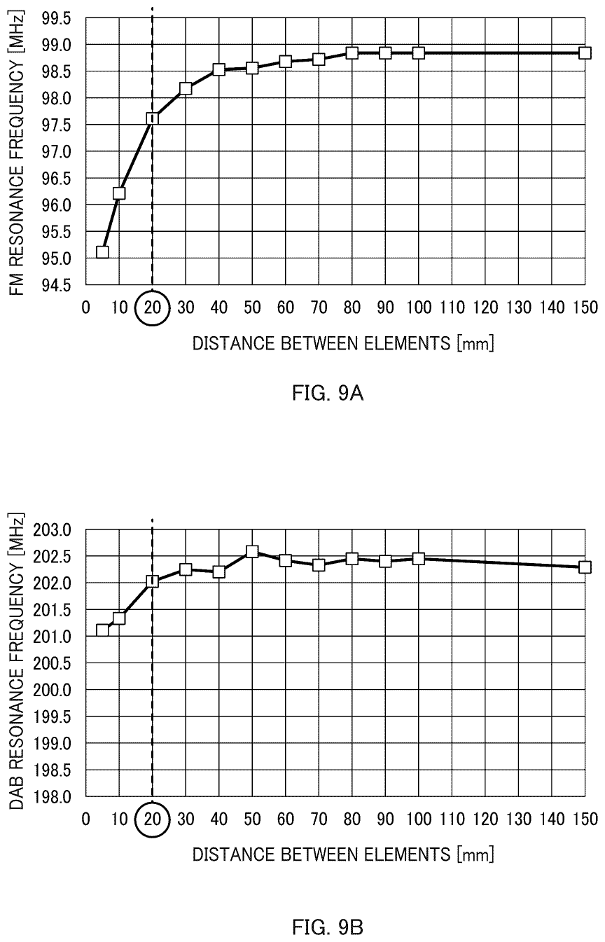

FIGS. 9A and 9B are graphs illustrating the relationship between the distance between the elements 25, 35 and the resonance frequencies of the antennas 2, 3. It can be seen that when the distance between the elements 25, 35 is 20 mm or less, both of the resonance frequencies of the elements 2, 3 vary significantly, and the designed performance cannot be obtained.

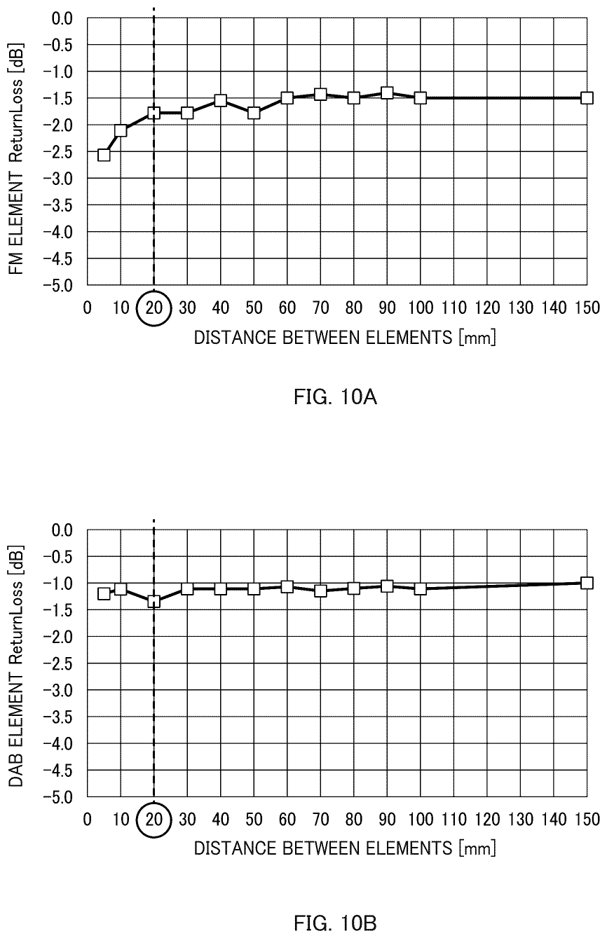

FIGS. 10A and 10B are graphs illustrating the relationship between the distance between the elements 25, 35 (distance between the sides thereof adjacent to each other) and the return loss of the antennas 2, 3. It can be seen that when the distance between the elements 25, 35 is 20 mm or less, particularly, the return loss of the element 3 varies significantly and the designed performance cannot be obtained.

With the distance between the elements 25, 35 being set to more than 20 mm, it is possible to prevent the degradation in the performance of the antennas 2, 3, but this inevitably results in an increase in the size of the antenna device 1A. Considering achievement of both miniaturizing the antenna device 1A as much as possible and maintaining the performance of the antennas 2, 3, it is preferable to set the distance between the elements 25 and 35, that is, the antennas 2 and 3, to 20 mm.

### (Distance Between Antennas 3, 4)

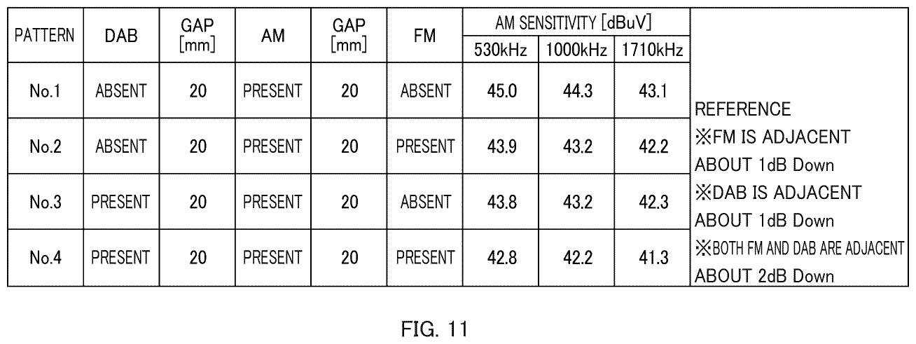

FIG. 11 illustrates the effects of the arrangement of the antennas 2, 3 on the sensitivity of the antenna 4. FIG. 11 illustrates the results of measuring the sensitivity of the antenna 4 in each of the following cases: when the antenna 4 is used alone (No. 1); when the antenna 2 is adjacent thereto (No. 2); when the antenna 3 is adjacent thereto (No. 3); and when the antennas 2, 3 are adjacent thereto on two sides thereof, respectively (No. 4). It is assumed that the distance between the antennas, that is, between the elements, is 20 mm.

As illustrated in FIG. 11, when the antennas 2, 3 are adjacent thereto (No. 4), a reduction in the sensitivity is limited to about 2 dB, as compared with the case where the antenna 4 is used alone (No. 1). When either the antenna 2 or 3 is arranged so as to be adjacent thereto (Nos. 2, 3), a reduction in the sensitivity of the antenna 4 is limited to about 1 dB.

As such, with the antenna 4 that supports the AM broadcast being arranged at an interval of 20 mm between the antenna 4 and the antenna 2, 3, it is possible to achieve a small-sized antenna device 1A, without causing a significant reduction in its performance.

Considering the order of arrangement, even if the antennas 2, 3 are arranged on two sides of the antenna, respectively, sufficient performance can be achieved. However, it is preferable to arrange either the antenna 2 or 3 so as to be adjacent to the antenna 4, as illustrated in FIGS. 5, 7A, and 7B.

(Permutations of antennas 2, 3, and 4)

Considering the permutations of the antennas 2, 3, and 4, it is preferable to place the antenna 4 at the right or left end in the three antennas, rather than in the middle as described above. Considering the arrangement of the antennas 2, 3, it is desirable to place the antenna 3 having a fractional bandwidth narrower than that of the antenna 2, in the middle. This is because the influence of the adjacent antenna on the resonant frequency increases as the fractional bandwidth of the antenna increases. Further, another reason is that a load on the entire device is smaller in the case where the frequency characteristics of the antenna 3, which has a narrower fractional bandwidth, is adjusted, than in the case where the frequency characteristics of the antenna 2 is adjusted. In this regard, the fractional bandwidth of the antenna 3 is 20% (frequency: 88 MHz to 108 MHZ) , and the fractional bandwidth of the antenna 2 is 32% (frequency: 174 MHZ to 240 MHZ).

As a result of the above considerations, as illustrated in FIGS. 5, 7A, and 7B, the antennas 2, 4 are arranged at the ends of the antenna device 1A, respectively, and the antenna 3 is arranged in the middle. With such an arrangement, the antenna device 1A exhibits good performance in any of the corresponding frequency bands of the antennas 2, 3, and 4.

### (Location of Antenna 5)

The antenna 5, which is a communication antenna used in V2X, is desirably mounted substantially at the center in the width direction of the vehicle C as described below.

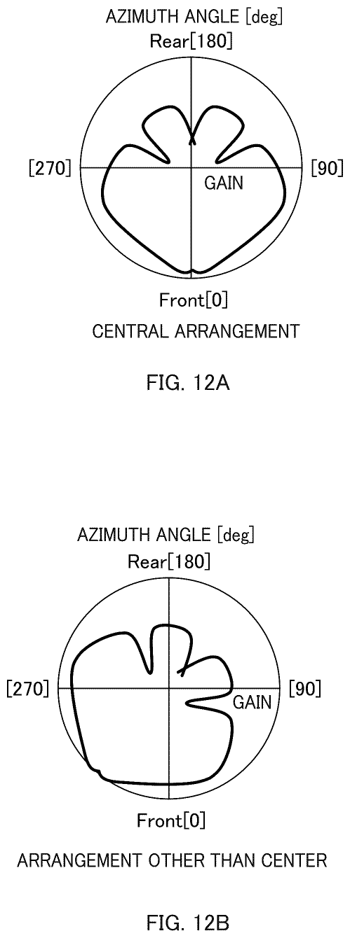

Considering vehicle-to-vehicle communication, it is desirable for the antenna 5 to have a directivity in the front and rear directions. Note that the antenna 5 may be configured with two antennas that obtain the gains in the front and rear directions of the vehicle C, thereby achieving a diversity effect. Incidentally, if the antenna 5 is not arranged substantially at the center in the width direction of the vehicle C (for example, when it is arranged at the end part in the width direction of the vehicle C), a tilt in the directivity occurs in the front-rear direction of the vehicle C, resulting in a reduction in the gain or the occurrence of null in a needed coverage area (FIG. 12B: illustrates the directivity in the front direction of the vehicle C). Note that as the arrangement thereof changes from the end part in the width direction of the vehicle C to substantially the center in the width direction, the tilt in the directivity is suppressed, thereby being able to obtain a symmetrical waveform.

In contrast, with the element 52 of the antenna 5 being arranged substantially at the center in the width direction of the vehicle C, the tilt in the directivity in the front-rear direction is eliminated, and thus the antenna 5 is able to have a directivity that is almost symmetrical in the left-right direction (FIG. 12A: illustrates the directivity in the front direction of vehicle C).

In addition, considering the improvement of the sensitivity of the antenna 5, it is desirable for the element 52 to be mounted at a position as high as possible. Thus, the base portion of the element 52 is fixed to the top face of the ground portion 51 (see FIG. 8).

### Another Embodiment of Arrangement of Antenna 5

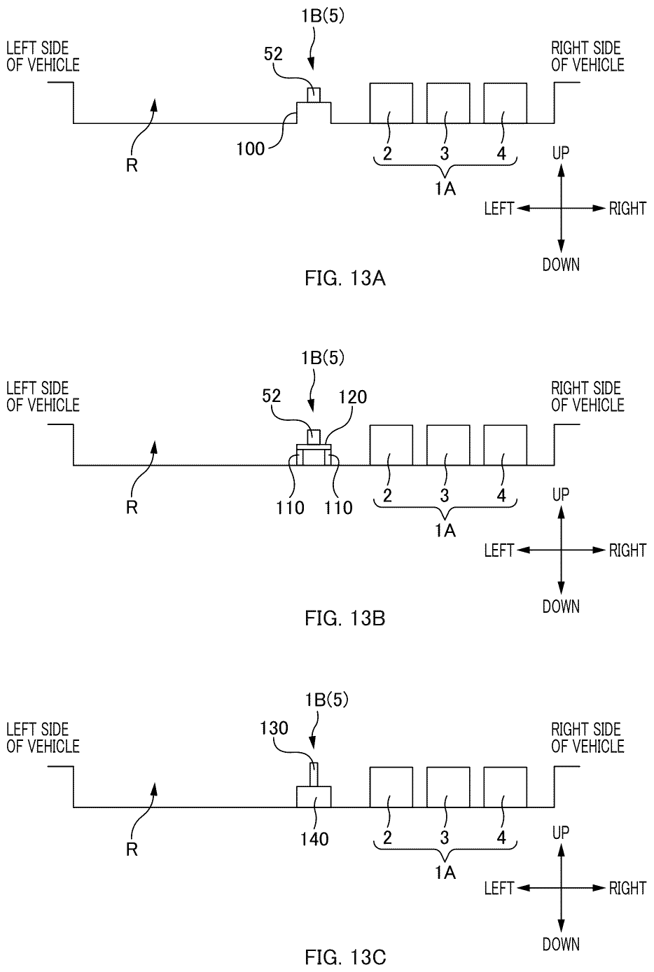

In FIG. 7B, the element 52 of the antenna 5 is provided to the ground portion 51 so as to be located at a higher position relative to the bottom face of the recessed portion R, but it is not limited thereto. For example, as illustrated in FIG. 13A, the element 52 may be arranged on a protruding portion 100 that is formed extending upward from the bottom face of the recessed portion R. Note that the protruding portion 100 is a portion formed by processing part of the recessed portion R of the vehicle C, and functions as the ground. In FIGS. 13A, 13B, and 13C, the roof panel C1 is omitted, for convenience.

Further, for example, in FIG. 13B, an insulating spacer 110 and a metallic plate-shaped ground portion 120 are provided, the insulating spacer 110 being provided at the bottom face of the recessed portion R, the ground portion 120 being supported by the spacer 110. In such a case, the element 52 may be arranged on the ground portion 120.

Further, it is assumed that the element 52 is an element that operates as a vertically polarized wave monopole antenna used in V2X communication, however, it is not limited thereto. For example, instead of the monopole element 52, an element 130, which operates as a vertically polarized wave dipole antenna used for V2X communication, may be used. When the element 130 as such is used, the element 130 only have to be placed on an insulating spacer 140 that is placed at the recessed portion R, as illustrated in FIG. 13C.

As illustrated in FIGS. 7B, 13A, 13B, and 13C, if the element 52, 130 can be placed at a higher position relative to the bottom face of the recessed portion R, the element 52, 130 will be less affected by other antennas. Accordingly, it is possible to prevent the reduction in the gain and the deterioration of the directivity of the element 52, 130 (i.e., the antenna 5 for V2X).

It is assumed, in an embodiment of the present disclosure, that the element 52, 130 supports V2X communication, but it may also be used in other communication standards having higher frequencies than the DAB frequency band and the FM frequency band. With the element (antenna) that supports the frequency band higher than the DAB frequency band being placed at a higher position, the similar effect as in an embodiment of the present disclosure can be obtained.

### Relationship Between Roof Panel C1 and Antenna

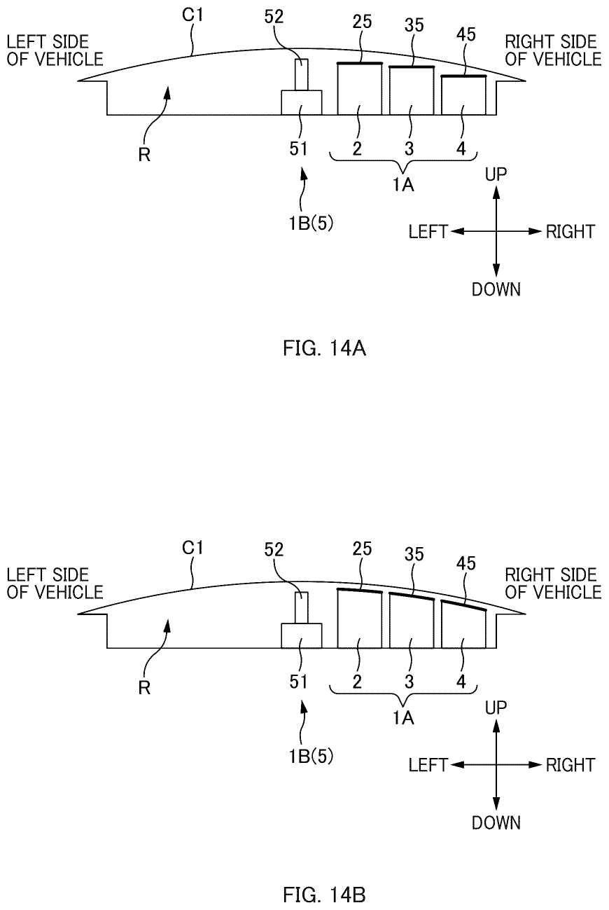

For example, as illustrated in FIG. 14A, the shape (here, height) of the ground portion 51 may be adjusted such that the top end of the element 52 is higher than the antenna 2. Even in such a case, as in FIG. 7B, the antenna 5 is at a high position, thereby being able to obtain good characteristics. It is assumed here that the height of the element 52 from the bottom face of the recessed portion R is higher than the height of the antenna 2, however, these two may be at the same height. Further, the height of the element 52 from the bottom face of the recessed portion R may be lower than the height of the antenna 2.

As illustrated in FIGS. 7B, 14A, and 14B, the roof panel C1 has an arc shape. Thus, the distance between the surface of the lower mold of the roof panel C1 and the bottom face of the recessed portion R is the longest near the center of the vehicle C, and gradually decreases from the center of the vehicle C toward the left-right directions.

Here, even if the antenna 4 of the AM frequency band is low in height, it is possible to secure the gain by increasing the length in the left-right direction. Accordingly, the antenna 4 for the AM frequency band is arranged at the end part of the vehicle C in the left-right direction (here, the right end part).

Further, the fractional bandwidth of the antenna 3, which supports the radio waves in the FM frequency band is narrower than the fractional bandwidth of the antenna 2, which supports the radio waves in the DAB frequency band. Here, it is difficult for the antenna having a large fractional bandwidth to obtain the gain in the entire frequency band, unless the height of the antenna is increased. Accordingly, in an embodiment of the present disclosure, the antenna 2 having a larger fractional bandwidth is provided on the center side of the vehicle C relative to the antenna 2.

Further, in an embodiment of the present disclosure, as illustrated in FIG. 14A, for example, the heights of the antennas 2, 3, and 4 gradually decrease from the center of the vehicle C toward the right end part of the vehicle C. With the heights of the antennas 2, 3, and 4 being varied as such, the gains of the antennas can be increased at respective positions. It is assumed, in an embodiment of the present disclosure, that the antennas 2, 3, and 4 have different heights, however, they may have the same height.

Further, in an embodiment of the present disclosure, the element 35 of the antenna 3 and the element 45 of the antenna 4 are supported so as to be substantially parallel to the ground portion 9, however, it is not limited thereto. For example, as illustrated in FIG. 14B, the elements 35, 45 may be supported so as to be higher on the center side of the vehicle C. Even in such a case, it is possible to obtain effect similar to that in an embodiment of the present disclosure.

### Arrangement of Diversity Antenna in Recessed Portion R

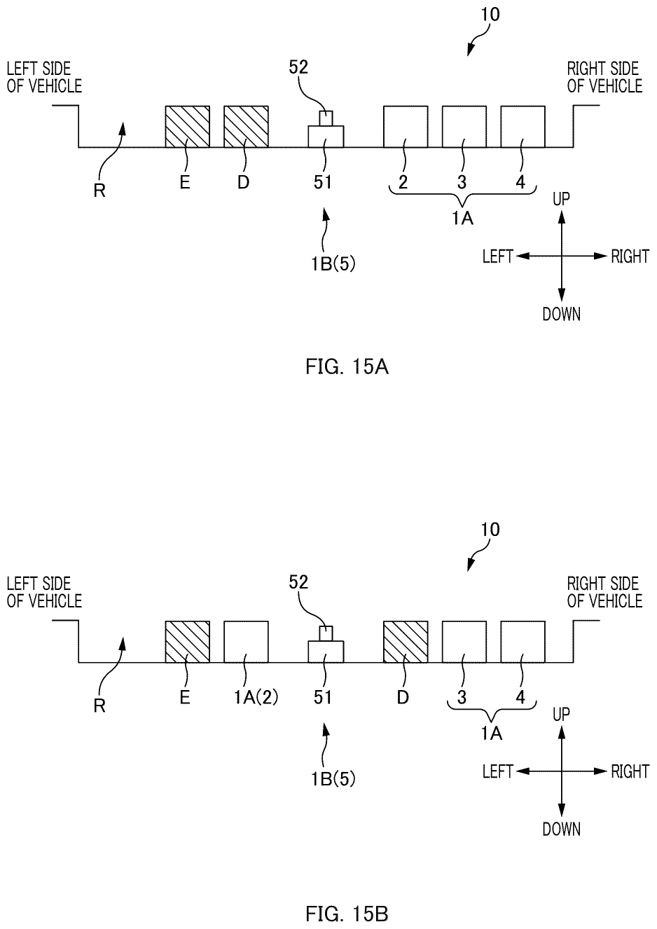

In an embodiment of the present disclosure, for example, in FIG. 7B, illustration of the antennas D, E is omitted, but in actuality, the antennas D, E are arranged, in addition to the antennas 2, 3, and 4, in the recessed portion R, as illustrated in FIG. 15A. For example, the antennas D, E may constitute a diversity antenna on the left and right in the vehicle such that the antennas that are the same as the antennas 2, 3 are arranged, in order to achieve a diversity effect with the antennas 2, 3. That is, in the antenna device 10 illustrated in FIG. 15A, the antennas 2, 3 are arranged on the right side relative to the antenna 5, and the antennas D, E are arranged on the left side relative to the antenna 5. Further, in the antenna device 10, a communication antenna for Wi-Fi or the like may also be newly mounted.

The arrangement of the antennas 2, 3, and 4 and the diversity antennas D, E is not limited thereto. For example, the arrangement illustrated in FIG. 15B may be employed. That is, in the antenna device 10 illustrated in FIG. 15B, the antennas D, 3 are arranged on the right side relative to the antenna 5, and the antennas E, 2 are arranged on the left side relative to the antenna 5. Further, when the antennas 2, 3, D, and E are communication antennas, they may be used as MIMO antennas.

The above describes embodiments and modifications of the present disclosure with reference to the drawings, but they are merely examples of the present disclosure, and various configurations other than those described above can also be adopted.

### Effect

In an embodiment of the present disclosure, the antenna device 10 includes a plurality of antennas 2, 3 (corresponding to a “first antenna” and a “second antenna”, respectively) that are arranged, at the vehicle C, along the width direction intersecting with the direction of travel of the vehicle C. The antenna 2 supports the radio waves in the DAB frequency band (corresponding to a “first frequency band”). The antenna 3 supports the FM frequency band (corresponding to a “second frequency band”) having a fractional bandwidth narrower than that of the DAB frequency band.

With a configuration described above, the antenna device 10 is able to suppress the effect on the resonance frequency; be placed in a narrow space as well; and exhibit high performance. This makes it possible to appropriately the plurality of antennas 2, 3 in an embodiment of the present disclosure. Further, it is possible to suppress the load on the amplifiers of the antennas 2, 3. By virtue of including the antennas 2, 3, the antenna device 10 is able to support a wide bandwidth.

The vehicle C includes the top face U and the recessed portion R that is recessed downward from the top surface U, and the antenna device 10 is arranged at the recessed portion R.

With a configuration described above, it is possible to mount the antenna device 10 to the vehicle C while suppressing the effect on the shape and the interior space of the vehicle C.

The antenna device 10 supports the radio waves in the frequency band of the medium-wave broadcast, and further includes the antenna 4, which is located on the outer side in the width direction relative to the antenna 3.

With a configuration described above, the antennas 2, 3, and 4 as a whole can suppress the effect on the resonance frequency and exhibit high performance. Further, it is possible to downsize the entire antenna device 10. Further, it is possible to suppress the load on the amplifiers of the antennas 2, 3, and 4.

The antennas 2, 3, and 4 are arranged at intervals, to thereby prevent interference among the antennas. That is, it is possible to suppress the effect on the resonance frequency.

At least one of the antennas 2, 3, and 4 includes the flat-plate-shaped element 25, 35, 45. With the achievement of a capacitively loaded type antenna including the element 25, 35, 45 as such, the antennas 2, 3, and 4 can reduce the height of the antenna and achieve a miniaturized device.

The antenna device 10 further includes a housing 7 configured to accommodate the antennas 2, 3, and 4, thereby facilitating mounting and transporting thereof with respect to the vehicle C.

The antenna device 10 further includes the antenna 5 (corresponding to a “vehicle communication antenna”) mounted to the vehicle C, wherein the antenna 5 is located on the center side in the width direction relative to the first antenna, and is communicatable with a vehicle other than the vehicle C.

With the antenna 5 being arranged near the center of the vehicle C, the antenna 5 can achieve good directivity, as illustrated in FIGS. 12A, 12B, and the like The antenna 5 is located at the ground portion 51 (corresponding to a “second portion”) that is positioned above the ground portion 9 (corresponding to a “first ground portion”) at which the antenna 2 and the antenna 3 are located.

By virtue of mounting the antenna at a high position, the antenna 5 is able to have high sensitivity.

The antenna device 10 further includes the antenna 6 (corresponding to a “satellite communication antenna”), which is mounted to the vehicle C, is located at the ground portion 51, and is configured to communicate with a satellite.

In an embodiment of the present disclosure, the antenna 2 is the DAB antenna, and the antenna 3 is the FM antenna. The antennas 2, 3 have good reception sensitivity.

### REFERENCE SIGNS LIST

1A, 1B, 10, 500 antenna device
2-6 antenna
7, 8 housing
9, 51 ground portion
25, 35, 45, 52, 130 element
C vehicle
R recessed portion

1. An antenna device including a plurality of antennas that are arranged, at a vehicle, along a width direction intersecting with a direction of travel of the vehicle, the antenna device comprising:
a first antenna supporting radio waves in a first frequency; and
a second antenna supporting radio waves in a second frequency band having a fractional bandwidth narrower than the fractional bandwidth of the first frequency, wherein
the second antenna is located on an outer side in the width direction of the vehicle relative to the first antenna.

2. The antenna device according to claim 1, wherein
the vehicle includes an upper face and a recessed portion that is recessed downward from the upper face, and
the antenna device is arranged at the recessed portion.

3. The antenna device according to claim 1, further comprising:
an Amplitude Modulation (AM) antenna supporting radio waves in a frequency band of a medium-wave broadcast, wherein
the AM antenna is located on an outer side in the width direction relative to the second antenna.

4. The antenna device according to claim 3, wherein the first antenna, the second antenna, and the AM antenna are arranged at intervals so as to prevent interference among the antennas.

5. The antenna device according to claim 3, wherein at least one of the first antenna, the second antenna, and the AM antenna includes a flat-plate-shaped element.

6. The antenna device according to claim 3, further comprising:
a housing configured to accommodate the first antenna, the second antenna, and the AM antenna.

7. The antenna device according to claim 1, further comprising:
a vehicle communication antenna mounted to the vehicle, wherein
the vehicle communication antenna is located on a center side in the width direction relative to the first antenna, and is communicatable with another vehicle other than the vehicle.

8. The antenna device according to claim 7, wherein the vehicle communication antenna is located at a second ground portion, the second ground portion being positioned above the first ground portion at which the first antenna and the second antenna are located.

9. The antenna device according to claim 8 further comprising:
a satellite communication antenna mounted to the vehicle, wherein
the satellite communication antenna is located at the second ground portion, and is configured to communicate with a satellite.

10. The antenna device according to claim 1, wherein the first antenna is a Digital Audio Broadcasting (DAB) antenna, and the second antenna is a Frequency Modulation (FM) antenna.

11. An antenna comprising:
one of a plurality of antennas that are included in an antenna device, the plurality of antennas being arranged, at a vehicle, along a width direction intersecting with a direction of travel of the vehicle,
the antenna being located on an outer side in the width direction of the vehicle relative to the first antenna supporting radio waves in a first frequency, the antenna supporting radio waves in a second frequency band having a fractional bandwidth narrower than the fractional bandwidth of the first frequency.

12. A vehicle mounted with a plurality of antennas that are arranged along a width direction intersecting with a direction of travel of the vehicle, the vehicle comprising:
a first antenna supporting radio waves in a first frequency; and
a second antenna supporting radio waves in a second frequency band having a fractional bandwidth narrower than the fractional bandwidth of the first frequency,
the first antenna and the second antenna being mounted in this order from a center to an outer side in the width direction of the vehicle.
